(19) United States
(12) Patent Application Publication
(10) Pub. No.: US 2007/0234915 A1
(43) Pub. Date: Oct. 11, 2007

(54) Rotating body of a web-fed press

(75) Inventors: Norbert Dylla, Stadtbergen (DE); Thomas John, Augsburg (DE); Thomas Kandlbinder, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG, Offenbach am Main (DE)

(21) Appl. No.: 11/731,311

(22) Filed: Mar. 30, 2007

(30) Foreign Application Priority Data
Mar. 31, 2006 (DE) 10 2006 014 968.8

(51) Int. Cl. B41F 13/10

(52) U.S. Cl. 101/375

(57) ABSTRACT

A rotating body of a web-fed press, in which one or more hot spots develop in at least one sector of at least one of two or more rotating bodies due to the rolling of the two or more rotating bodies on one another. The rotating body has at least one inhomogeneity in the form of a material recess, so that heat conduction or thermal expansion is interrupted at the site of the material recess.

### BACKGROUND OF THE INVENTION

1. Field of the Invention

The invention concerns a rotating body of a web-fed press, in which one or more hot spots develop in at least one sector of at least one of two or more rotating bodies due to the rolling of the two or more rotating bodies on one another.

2. Description of the Related Art

In web-fed presses, when a rotating body with a soft surface, for example, a blanket cylinder covered with a rubber blanket or rubber blanket plate or a blanket cylinder fitted with a rubber sleeve, rolls on a second rotating body with the same surface or with a hard surface, local heating can occur in one or both of the rotating bodies. The areas of local heating are referred to in the printing industry as hot spots. Hot spots cause unbalanced linear expansion and thus curvature of the rotating bodies, which in turn leads to eccentric running of the rotating bodies.

Especially slender cylinders in web-fed presses, especially transfer cylinders, show a tendency to develop hot spots during operation at high speed due to the flexing work of blankets or blanket plates.

### SUMMARY OF THE INVENTION

An object of the invention is to design a rotating body of a web-fed press in a way that diminishes or completely eliminates the curvature of the rotating body caused by the hot-spot effect.

The inventors came to the realization that heat transfer in the rotating body and the associated thermal expansion of the rotating body can be reduced or prevented by introducing inhomogeneities in the rotating body. An inhomogeneity is understood to mean, for example, a material recess or a plurality of material recesses in the material of the rotating body, by which heat conduction at the site of the material recess is interrupted or thermal expansion is locally limited.

As a result of the insights gained by the inventors, they propose that, in a web-fed press, in which one or more hot spots develop in at least one sector of at least one of two or more rotating bodies due to the rolling of the two or more rotating bodies on one another, a rotating body be improved by providing it with at least one inhomogeneity in the form of a material recess, so that heat conduction or thermal expansion is interrupted at the site of the material recess.

The inventors define rotating bodies as, for example, forme cylinders, specifically, plate cylinders, blanket cylinders, impression cylinders, film rollers, vibrator rollers, inking rollers, dampening rollers, fountain rollers or even web guide rollers.

The propagation of hot spots and thus unbalanced linear expansion can be greatly reduced or prevented by the material recesses. Thermally produced curvature or bowing of the rotating body are thus prevented, and printing press errors due to eccentric running are avoided.

The material recess can be formed as a groove that extends at least partially around the circumference of the rotating body. For example, this groove can be milled into the cylindrical surface of the rotating body.

Alternatively or additionally, the groove can also be formed on at least one of the end faces of the rotating body. The propagation of heat in the direction of the axle journal can be reduced in this way.

The groove can be spirally and/or helically formed. The effective surface or effective plane of the groove acting as a thermal barrier can be varied by the number or angle of the winding(s) of the spiral and/or helical groove.

Alternatively or additionally to the groove embodiment, the material recess also can be formed as at least one axially and/or radially extending bore in the rotating body.

The groove or the bore preferably has a width or a diameter in the range of 0.1 mm to 50 mm and a depth in the range of 1 mm to the maximum cylinder diameter.

The rotating body can also be composed of a plurality of parts, preferably a plurality of disks, such that at least some of the disks have at least a portion of the material recess. For example, disks with a larger diameter can be combined with disks with a smaller diameter by alternating them. The multiple-part construction makes it possible to combine materials with different insulating properties.

It is advantageous if the material recess is filled with a thermally insulating material. As an alternative to air, which has a thermal conductivity of 0.002 (W/(K×m)), the use of a filler in the material recess makes it possible not only to provide thermal insulation but also to improve the rigidity of the rotating body.

If the material recesses in the rotating body are formed as closed spaces, they can also be filled with fluid media. To optimize the insulating effect even more, the closed spaces can be evacuated or filled with a gas that is a poor thermal conductor.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 is a side view of a rotating body with two ring grooves;

FIG. 2 is a side view of a rotating body with two spiral grooves;

FIG. 3 is a side view of a rotating body made of a plurality of assembled disk elements;

FIG. 4 is a longitudinal section through a rotating body with a groove formed in each end surface;

FIG. 5 is a longitudinal section through a rotating body with two bores that pass completely through the rotating body parallel to its axis; and

FIG. 6 is a longitudinal section through a rotating body with a plurality of blind bores.

### DETAILED DESCRIPTION OF THE PRESENTLY PREFERRED EMBODIMENTS

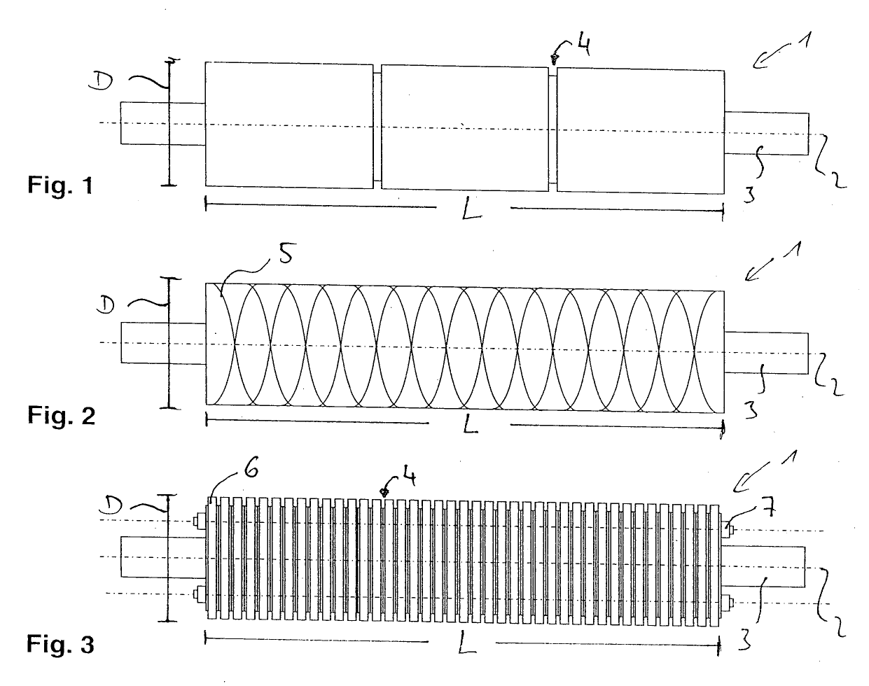

FIG. 1 shows a side view of a rotating body 1 with two ring grooves 4. The rotating body 1, which has a diameter D and a barrel length L, has two axle journals 3, which support it in a web-fed press. The rotating body 1 rotates about the axis of rotation 2 when the web-fed press is in operation. In this embodiment of the rotating body 1, two ring grooves 4 are formed in the cylindrical surface of the rotating body 1 to prevent or reduce the propagation of hot spots. It is also possible to form grooves 4 that extend only partially around the circumference of the rotating body 1. Furthermore, it is possible for only one groove 4 or more than two grooves 4 to be placed along the length L of the rotating body 1. The hot spots, which can cause uneven temperature elevation in the rotating body 1, together with the accompanying nonuniform linear expansion, result in the bowing of the rotating body. The grooves 4 interrupt the thermal conduction and the thermal expansion by changing the heat conduction process in the vicinity of the groove 4 to a heat transfer process, the heat being transferred to the medium in the groove 4. The grooves 4 formed in FIG. 1 preferentially interrupt heat conduction in direction L of the rotating body 1. The grooves 4 or, in general, the material recesses in the rotating body 1 can be made in the rotating body 1, for example, by shaping or by material removal. The grooves 4 can have cross sections other than the rectangular cross section shown in FIG. 1, such as circular, oval, or polygonal cross sections. For example, a circular or oval cross section can increase the surface area in the groove and thus enhance the interruption of the heat conduction.

FIG. 2 shows a side view of another embodiment of a rotating body 1 of the invention. The grooves in this embodiment are formed as two spiral grooves 5 running in opposite directions.

FIG. 3 shows a side view of another rotating body 1 of a web-fed press. This rotating body 1 has a plurality of ring grooves 4 formed on its cylindrical surface. The special feature of this rotating body 1 is that it consists of a plurality of disk elements 6 that are joined with a plurality of bolts 7. The periphery of each disk element 6 has a step, and two steps of adjacent disk elements 6 form a groove 4. Alternatively, the grooves can be formed by an alternating arrangement of disks with two different diameters. One advantage of this structure of the rotating body is that disk elements 6 with different thermal conductivities can alternate with each other. The propagation of heat along the axis 2 of the rotating body can thus be adjusted according to requirements. Another advantage of this structure is that the junction sites of the disk elements 6 that are bolted together also act as thermal barriers. Compared to this disk structure, a rotating body 1 that consists of a solid material is a better conductor of the thermal energy of the hot spots.

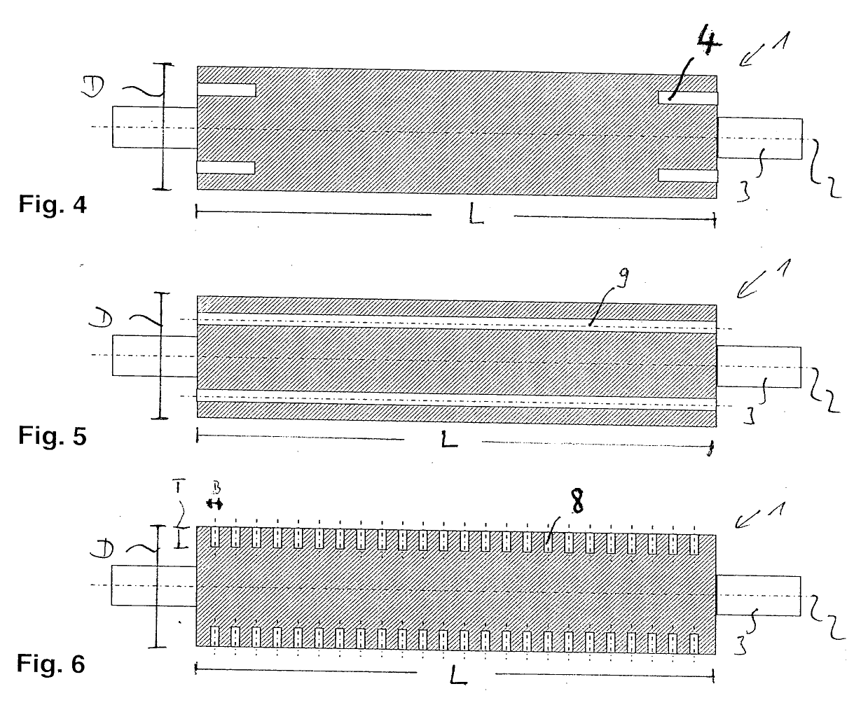

FIG. 4 shows another rotating body 1 in longitudinal section. Alternatively or additionally to the material recesses on the cylindrical surface of the rotating body 1, material recesses can be formed in the ends of the rotating body 1. Annular grooves 4 are formed in the ends of the rotating body 1 in FIG. 4. The depth of these grooves 4 extends only partially along the barrel length L of the rotating body 1.

FIG. 5 shows the rotating body 1 of FIG. 4, but in contrast to the rotating body 1 of FIG. 4, the ends have bores 9 that extend along the entire barrel length L of the rotating body 1.

FIG. 6 shows a longitudinal section through a rotating body 1 along the barrel length L with a plurality of blind bores 8 drilled into the cylindrical surface of the rotating body 1. These blind bores 8 preferably have a width B or a diameter in the range of 0.1 mm to 50 mm and a depth T in the range of 1 mm to the maximum cylinder diameter.

It should also be pointed out that it is not necessary for the material recesses to be visible on the surface of the rotating body. For example, in a multiple-part design of the rotating body, such as a rotating body composed of disk elements, the material recesses can be located inside the individual parts that constitute the rotating body.

It is understood that the aforementioned features and the features specified in the claims can be used not only in the particular combinations that have been specified but also in other combinations or by themselves without exceeding the scope of the invention.

The invention is not limited by the embodiments described above which are presented as examples only but can be modified in various ways within the scope of protection defined by the appended patent claims.

We claim:

1. A rotating body which rolls against another rotating body in a web-fed press, said rotating body comprising:
a circumferential surface concentric to an axis of rotation;
a pair of opposed end faces; and
at least one material recess which interrupts conduction of heat so that non-uniform linear expansion is at least reduced.

2. The rotating body of claim 1 wherein said material recess comprises a groove which extends at least partially around the circumference of the rotating body.

3. The rotating body of claim 2 wherein the groove is formed as a helix around the circumferential surface.

4. The rotating body of claim 2 wherein the groove has a width of 0.1 mm to 50 mm.

5. The rotating body of claim 1 wherein said at least one recess comprises at least one bore in the circumferential surface.

6. The rotating body of claim 5 wherein the bore has a depth of 1 mm up to the diameter of the rotating body.

7. The rotating body of claim 1 wherein the bore extends parallel to the axis.

8. The rotating body of claim 1 wherein said at least one material recess comprises a plurality of ring grooves extending around the circumferential surface, said rotating body comprising a plurality of coaxially arranged disks, at least some of said disks having a circumferential portion forming a base of a respective said groove.

9. The rotating body of claim 8 wherein said disks comprise first disks having a first diameter and second disks having a second diameter which is smaller than said first diameter, said second disks consisting of a different material than said first disks.

10. The rotating body of claim 1 further comprising a thermally insulating material filling said at least one material recess.

11. The rotating body of claim 10 wherein said thermally insulating material is in a solid state at 20° C. and has a thermal conductivity of 0.05 (W/(K×m)) to 40 (W/(K×m)).

12. The rotating body of claim 10 wherein said thermally insulating material is in a liquid state at 20° C. and has a thermal conductivity of 0.1 (W/(K×m)) to 10 (W/(K×m)).

13. The rotating body of claim 10 wherein said thermally insulating material is in a gaseous state at 20° C. and has a thermal conductivity of 0.01 (W/(K×m)) to 0.3 (W/(K×m)).

14. The rotating body of claim 1 wherein said material recess comprises a groove in at least one of said end faces of said rotating body.
